(19) United States
(12) Patent Application Publication
(10) Pub. No.: US 2022/0206193 A1
(43) Pub. Date: Jun. 30, 2022

(54) LIQUID LENSES AND LIQUID LENS ARTICLES WITH LOW REFLECTIVITY ELECTRODE STRUCTURES

(71) Applicant: CORNING INCORPORATED, Corning, NY (US)

(72) Inventors: Robert Alan Bellman, Ithaca, NY (US); Raymond Miller Karam, Santa Barbara, CA (US); Marie Bernadette O'Regan, Santa Barbara, CA (US); Shiva Prakash, Santa Barbara, CA (US)

(21) Appl. No.: 17/610,024

(22) PCT Filed: May 7, 2020
(86) PCT No.: PCT/US2020/031742

§ 371 Date: Nov. 9, 2021

Related U.S. Application Data
(60) Provisional application No. 62/847,093, filed on May 13, 2019.

(51) Int. Cl. G02B 3/14; G02B 26/00

(52) U.S. Cl. CPC G02B 3/14; G02B 26/005

(57) ABSTRACT

A liquid lens article that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 mm to 700 nm, and a reflectivity of about 25% or less at an ultraviolet wavelength within a range of 100 nm to 400 nm. Further, the absorber structure comprises an absorber layer comprising a metal oxynitride and the electrically conductive structure comprises a metal layer comprising a metal that differs from the metal of the absorber layer of the absorber structure. In addition, the electrode can comprise a sheet resistance from about 5 Ω/sq to about 0.5 Ω/sq.

### CROSS-REFERENCE TO RELATED APPLICATIONS

This application claims the benefit of priority under 35 U.S.C. § 119 of U.S. Provisional Application No. 62/847,093 filed May 13, 2019, the content of which is incorporated herein by reference in its entirety.

### FIELD OF THE DISCLOSURE

The disclosure relates to liquid lenses and liquid lens articles with low reflectivity electrode structures and, more particularly, to such liquid lenses and articles with electrode structures suitable for laser bonding process steps.

### BACKGROUND

Liquid lenses generally include two immiscible liquids disposed within a chamber. Varying an electric field applied to the liquids can vary the wettability of one of the liquids relative to walls of the chamber, which has the effect of varying the shape of a meniscus formed between the two liquids. Further, in various applications, changes to the shape of the meniscus can drive controlled changes to the focal length of the lens.

One challenge associated with manufacturing a liquid lens is forming a hermetic bond between the substrates of the lens. These substrates may be made from glass, glass-ceramics, ceramics, polymers, and other high modulus materials, which present difficulties in forming reliable, hermetic bonds. Further, the bonding steps are often conducted in a wet environment in close proximity to the liquids employed by the lens for its optical function. In addition, the substrates of the liquid lens also comprise conductive electrodes, which are often dissimilar in composition and structure relative to the substrates.

Accordingly, there is a need for liquid lens and liquid lens article configurations suitable for substrate bonding, particularly laser bonding processes.

### SUMMARY OF THE DISCLOSURE

According to some aspects of the present disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises an absorber layer comprising a metal oxynitride and the electrically conductive structure comprises a metal layer comprising a metal that differs from the metal of the absorber layer of the absorber structure.

According to other aspects of the present disclosure, a liquid lens article is provided that includes: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises an absorber layer comprising a metal oxynitride and the electrically conductive structure comprises a metal layer comprising a metal that differs from the metal of the absorber layer of the absorber structure. In addition, the electrode comprises a sheet resistance from about 5 Ω/sq to about 0.5 106 /sq.

According to other aspects of the present disclosure, a liquid lens is provided that includes: a first substrate; an electrode disposed on a primary surface of the first substrate and comprising an electrically conductive structure disposed on the primary surface of the first substrate and an optical absorber structure disposed on the electrically conductive structure; a second substrate disposed on the absorber structure of the electrode; a bond defined at least in part by the electrode, wherein the bond hermetically seals the first substrate and the second substrate; a cavity defined at least in part by the bond; and a first liquid and a second liquid disposed within the cavity. Further, the electrode comprises a reflectivity minimum of about 3% or less at a visible wavelength within a range of 390 nm to 700 nm, and a reflectivity of about 25% or less at an ultraviolet wavelength within a range of 100 nm to 400 nm. The absorber structure comprises an absorber layer comprising a metal oxynitride and the electrically conductive structure comprises a metal layer comprising a metal that differs from the metal of the absorber layer of the absorber structure. In addition, the first liquid and the second liquid are substantially immiscible such that an interface between the first liquid and the second liquid defines a lens of the liquid lens.

In some aspects of the foregoing liquid lenses, the electrode can comprise a sheet resistance from about 5 Ω/sq to about 0.5 Ω/sq. Further, the bond can comprise an optical transmittance of at least 70% at an infrared wavelength within a range of 800 nm to 1.7 μm.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic, cross-sectional view of embodiments of a liquid lens;

FIG. 2 is an enlarged view of the liquid lens depicted in FIG. 1 showing a liquid lens article comprising a first substrate, a second substrate, an electrode between the substrates and a bond defined at least in part by the electrode, according to embodiments;

FIGS. 2A-2C are schematic, cross-sectional views of embodiments of a liquid lens article with an electrode disposed on a first substrate with varying configurations;

FIGS. 3A-3C are box plots of measured parameters of liquid lenses fabricated with a comparative Cr/CrOₓN_{y} electrode configuration and an exemplary Ni/Cr/CrOₓN_{y} electrode configuration, according to embodiments;

FIGS. 4A-4C are box plots of parameters of liquid lenses, as measured in a tilted configuration, and as fabricated with a comparative Cr/CrOₓN_{y} electrode configuration and an exemplary Ni/Cr/CrOₓN_{y} electrode configuration, according to embodiments; and

FIG. 5 is a plot of hysteresis vs. optical power of liquid lenses, as fabricated with an exemplary Ni/Cr/CrOₓN_{y} electrode configuration, according to embodiments.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “reflectance” and “reflectivity” are synonymous and used interchangeably in this disclosure.

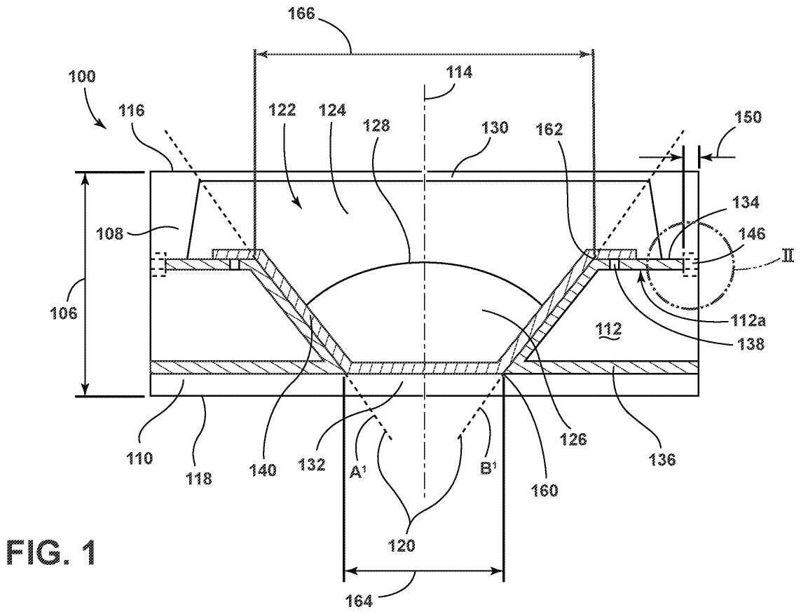

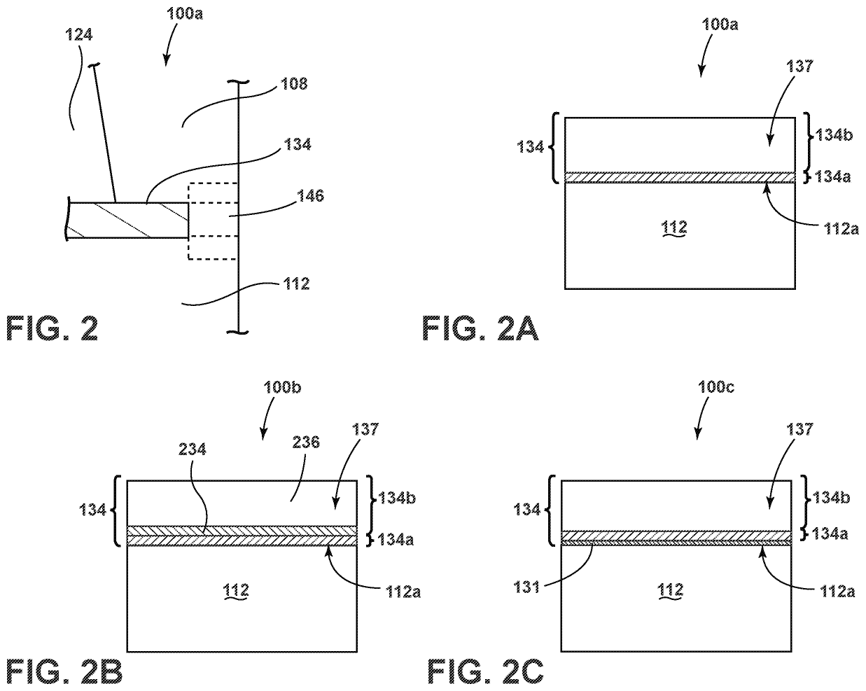

In various embodiments of the disclosure, a liquid lens article is provided that includes a first substrate and an electrode disposed on a primary surface of the substrate (e.g., the liquid lens articles 100a depicted in FIGS. 2A-2C and detailed below). The electrode can include an electrically conductive structure disposed on the primary surface of the substrate and an optical absorber structure disposed on the electrically conductive structure. The electrode can be characterized by a reflectivity minimum of about 3% or less at a visible wavelength, and a reflectivity of about 25% or less at an ultraviolet wavelength. The electrode can also be characterized by a sheet resistance from about 5 Ω/sq to about 0.5 Ω/sq. Further, the absorber structure can comprise an absorber layer comprising a metal oxynitride (e.g., CrOₓN_{y}) and the electrically conductive structure can comprise a metal layer comprising a metal (e.g., Ni) that differs from the metal of the absorber layer (e.g., Cr). In some aspects, the absorber layer comprises an outer absorber layer disposed over an inner absorber layer, the outer absorber layer comprising CrOₓN_{y} and the inner absorber layer comprising Cr; and the electrically conductive structure comprises a Ni metal layer. In addition, some of the liquid lens article embodiments further include a second substrate disposed on the optical absorber structure of the electrode and a bond defined at least in part by the electrode and the substrates (e.g., the liquid lens article 100a depicted in FIG. 2A and detailed below). Further, the disclosure includes liquid lens configurations that incorporate these liquid lens articles (e.g., the liquid lens 100 depicted in FIG. 1 and detailed below). Such liquid lens configurations can also include an additional electrode and third substrate (e.g., a second electrode 136 and third substrate 110 depicted in FIG. 1 and detailed below), in some implementations.

The electrode structures detailed in this disclosure can enable, or otherwise positively influence, the achievement of various technical requirements and performance aspects of the devices employing the implementations of the liquid lens articles and lenses of the disclosure. Among these technical considerations, the electrodes should provide enough current carrying capability to allow for the induced voltage variations for proper operation of the liquid lens device. Higher current density carrying capabilities in the electrodes can be advantageous, however, to enable the patterning of resistance-based heaters from the electrode that can heat the device to improve liquid lens operation under sub-zero temperature evolutions. The liquid lens device should also be configured to suppress optical reflections in the cone containing the liquids of the liquid lens. As such, the electrodes of the disclosure are configured to have low reflectivity in the visible wavelength regime to suppress stray optical reflections within the core for optimal liquid lens device performance. Another technical consideration is that the sealing of the substrates of the liquid lens can be limited by the materials and configuration of the electrodes. In view of this consideration, the electrodes of the disclosure can enable the laser bonding of the substrates by exhibiting a low reflectivity in the ultraviolet wavelength regime, particularly at those wavelengths of the laser employed by the bonding process. Further, the electrodes of the disclosure can facilitate laser dicing of liquid lens devices from an array of such devices. In particular, the electrodes of the disclosure are amenable to a laser bond formed from the substrates and the electrode that is substantially transparent to the wavelength of infrared lasers employed to dice the individual liquid lens devices from an array of such devices. Interconnection performance is another important technical consideration of liquid lens devices. The electrodes of the disclosure have the advantage of being amenable to etching or patterning processes in which one etchant is employed to etch the optical absorber structure without etching the underlying electrically conductive structure. In contrast, conventional liquid lens electrodes often require multiple etchants and/or etchant stop layers, which increase the cost of interconnections.

Referring to FIG. 1, a liquid lens 100 is provided that includes: a first substrate 112 (also referred herein as “intermediate layer 112”); an electrode 134 disposed on a primary surface 112a of the first substrate 112; and a second substrate 108 (also referred herein as a “first outer layer 108”) disposed on the electrode 134. The liquid lens 100 also includes a bond 146 defined at least in part by the electrode 134, wherein the bond 146 hermetically seals the first substrate 112 and the second substrate 108. The liquid lens 100 further includes a cavity 122 defined at least in part by the bond 146; and a first liquid 124 and a second liquid 126 disposed within the cavity 122. In addition, the first liquid 124 and the second liquid 126 are substantially immiscible such that an interface 128 between the first liquid 124 and the second liquid 126 defines a lens (e.g., by refracting image light passing through the interface 128) of the liquid lens 100. Further, the electrode 134 is characterized by a reflectivity minimum of about 3% or less at a visible wavelength within a range of 390 nm to 700 nm, a reflectivity of about 25% or less at an ultraviolet wavelength within a range of 100 nm to 400 nm, and a sheet resistance from about 5 Ω/sq to about 0.5 Ω/sq. In addition, the bond 146 can be characterized by an optical transmittance of at least about 70% at an infrared wavelength within a range of 800 nm to 1700 nm. In some implementations of the liquid lens 100, the electrode 134 can be characterized by a reflectivity of about 10% or less at the ultraviolet wavelength within the range of 100 nm to 400 nm. In further implementations of the liquid lens 100, the electrode 134 can be characterized by a reflectivity minimum of about 1% or less at the visible wavelength within the range of 390 nm to 700 nm, and a reflectivity of about 5% or less at the ultraviolet wavelength within the range of 100 nm to 400 nm.

According to an exemplary implementation of the liquid lens 100 of the disclosure depicted in FIG. 1, the electrode 134 comprises an electrically conductive structure 134a disposed on the primary surface 112a of the first substrate 112 and an optical absorber structure 134b disposed on the electrically conductive structure 134a (see FIGS. 2A-2C). Further, the absorber structure 134b comprises an absorber layer 137 comprising a metal oxynitride (e.g., CrOₓN_{y}) and the electrically conductive structure 134a comprises a metal layer comprising a metal (e.g., Ni) that differs from the metal (e.g., Cr) of the absorber layer 137 of the absorber structure 134b (see FIG. 2A). In some embodiments, the absorber layer 137 comprises an outer absorber layer 236 disposed over an inner absorber layer 234, the outer absorber layer 236 comprising CrOₓN_{y} and the inner absorber layer 234 comprising Cr; and the metal layer of the electrically conductive structure 134a comprises Ni (see FIG. 2B). In some implementations, the electrode 134 can be configured with an adhesion layer 131 (e.g., NiOₓ), with the adhesion layer 131 located between the primary surface 112a of the first substrate 112 and the metal layer of the electrically conductive structure 134a. According to some embodiments, such an adhesion layer 131 can improve the galvanic corrosion resistance of the absorber structure 134b, as comprising a Cr/CrOₓN_{y} structure. In some embodiments, the metal of each of the electrically conductive structure 134a and the absorber layer 137 can include Cr, Mo, Au, Ag, Ni, Ti, Cu, Al, V, W, Zr, a Ni/V alloy, a Ni/Au alloy, a Au/Si alloy, a Cu/Ni alloy, other alloys thereof, or combinations thereof. In one exemplary implementation, the absorber layer 137 is CrOₓN_{y} and the electrically conductive structure 134a is a Ni metal layer. In another exemplary implementation, the absorber layer 137 includes an outer absorber layer 236 of CrOₓN_{y} disposed over an inner absorber layer 234 of Cr and the electrically conductive structure 134a is a Ni metal layer.

In some embodiments, the liquid lens 100 has an optical axis 114. The first outer layer 108 has an external surface 116. In embodiments, the liquid lens 100 has a third substrate 110 (also referred herein as “second outer layer 110”), which likewise has an external surface 118. The thickness 106 of the liquid lens 100 is defined by the distance between the external surface 116 of the first outer layer 108 and the external surface 118 of the second outer layer 110. The intermediate layer 112 (also referred herein as the “first substrate 112”) has a through hole 120 denoted by dotted lines A′ and B′. The optical axis 114 extends through the through hole 120. The through hole 120 is rotationally symmetric about the optical axis 114, and can take a variety of shapes, for example, as set forth in U.S. Pat. No. 8,922,901, which is hereby incorporated by reference in its entirety. The first outer layer 108, the second outer layer 110, and the through hole 120 of the intermediate layer 112 define a cavity 122. In other words, the cavity 122 is disposed between the first outer layer 108 and the second outer layer 110, and within the through hole 120 of the intermediate layer 112. In implementations of the liquid lens 100, the first outer layer 108, the second outer layer 110, and the intermediate layer 112 are all transparent (e.g., with an optical transmittance of at least 70%) to the wavelength of a laser (e.g., 1060 nm for an infrared CO₂ laser) employed for liquid lens dicing operations (e.g., to dice or otherwise separate a liquid lens 100 from a plurality of liquid lenses 100). A small gap (not illustrated) may separate each of the first outer layer 108, the second outer layer 110, and the intermediate layer 112 from their adjacent layer. The through hole 120 has a narrow opening 160 and a wide opening 162. The narrow opening 160 has a diameter 164. The wide opening 162 has a diameter 166. In some embodiments, the diameter 166 of the wide opening 162 is greater than the diameter 164 of the narrow opening 160.

Referring again to FIG. 1, the liquid lens 100 further includes a first liquid 124 and a second liquid 126 disposed within the cavity 122. Because of the properties of the first liquid 124 and the second liquid 126, the first liquid 124 and the second liquid 126 separate from one another at the interface 128. In embodiments, the first liquid 124 and second liquid 126 are non-miscible or substantially non-miscible. The first liquid 124 can be a polar liquid or a conducting liquid. Additionally, or alternatively, the second liquid 126 can be a non-polar liquid or an insulating liquid. The first liquid 124 can be substantially immiscible with, and has a different refractive index than, the second liquid 126, such that the interface 128 between the first liquid 124 and the second liquid 126 forms, thus making a lens. The first liquid 124 and the second liquid 126 can have substantially the same density, which can help to avoid changes in the shape of the interface 128 as a result of changing the physical orientation of the first liquid lens 100 (e.g., as a result of gravitational forces).

Again referring to FIG. 1, the liquid lens 100 further includes a first window 130 and a second window 132. The first window 130 can be part of the first outer layer 108. The second window 132 can be part of the second outer layer 110. For example, a portion of the first outer layer 108 covering the cavity 122 serves as the first window 130, and a portion of the second outer layer 110 covering the cavity 122 serves as the second window 132. In some embodiments, image light enters the first liquid lens 100 through the first window 130, is refracted at the interface 128 between the first liquid 124 and the second liquid 126, and exits the first liquid lens 100 through the second window 132.

The first outer layer 108 and/or the second outer layer 110 can comprise a sufficient transparency to enable passage of the image light. For example, the first outer layer 108 and/or the second outer layer 110 can comprise a polymeric, a glass, ceramic (e.g., a silicon wafer), or glass-ceramic material. Because image light can pass through the through hole 120 in the intermediate layer 112, the intermediate layer 112 need not be transparent to the image light. However, the intermediate layer 112 can be transparent to the image light. As noted earlier, the first outer layer 108, the second outer layer 110, and the intermediate layer 112 can all be transparent to the wavelength of a laser employed for liquid lens dicing operations. The intermediate layer 112 can comprise a metallic, polymeric, a glass, ceramic, or glass-ceramic material. In the illustrated embodiment, each of the first outer layer 108, the second outer layer 110, and the intermediate layer 112 comprise a glass material.

Referring again to the liquid lens 100 depicted in FIG. 1, the external surfaces 116, 118 of the first outer layer 108 and/or the second outer layer 110, respectively, can be, and in the illustrated embodiment, are substantially planar. Thus, although the first liquid lens 100 can function as a lens (e.g., by refracting image light passing through the interface 128), the external surfaces 116, 118 of the first liquid lens 100 can be flat, e.g., as distinct from the curved outer surfaces of a typical conventional, convex fixed lens. In other embodiments of the liquid lens 100, the external surfaces 116, 118 of the first outer layer 108 and/or the second outer layer 110, respectively, can be curved (e.g., concave or convex). Thus, the first liquid lens 100 comprises an integrated fixed lens.

As noted earlier, the liquid lens 100 further includes a first electrode 134 and a second electrode 136. The first electrode 134 is disposed between the first outer layer 108 and the intermediate layer 112 (first substrate 112). The second electrode 136 is disposed between the intermediate layer 112 and the second outer layer 110 and extends through the through hole 120 in the intermediate layer 112. The first electrode 134 and the second electrode 136 can be applied (such as by coating or sputtering) to the intermediate layer 112 as one contiguous electrode layer structure before the first outer layer 108 and the second outer layer 110 are attached to the intermediate layer 112. In other words, substantially all of the intermediate layer 112 can be coated with an electrode. The electrode layer or layer structure can then be segmented into the first electrode 134 and the second electrode 136. For example, the liquid lens 100 can include a scribe 138 in the electrode layer or structure to form or otherwise define the first electrode 134 and the second electrode 136 such that these electrodes are electrically isolated from one another. In embodiments, one or more intermediate layer(s) are present between the electrodes 134, 136 and either or both of the first outer layer 108 and the first substrate 112 (not shown) (e.g., intermediate layer(s) of varying compositions to match the refractive indices of the layers 108, 112 with the electrodes 134, 136; e.g., intermediate layer(s) of varying compositions to promote deposition of the electrodes 134, 136 over the layers 108 and/or 112, etc.). According to one exemplary implementation, the electrodes 134, 136 can comprise an adhesion layer (e.g., NiOₓ) disposed between the primary surface of respective layers 108, 112 and the metal layer of the electrically conductive structure of these electrodes 134, 136 (e.g., an adhesion layer 131 between electrically conductive structure 134a and primary surface 112, as shown in FIG. 2C).

In some embodiments, the first electrode 134 and the second electrode 136 are not transparent to the wavelength of a laser employed in laser dicing operations (e.g., at 1060 nm for an infrared CO₂ laser). Various configurations and materials that can be employed in the electrodes 134, 136 are shown in FIGS. 2A-2C, described in detail below. More generally, each of the first electrode 134 and the second electrode 136 can comprise one or more metal-containing materials (e.g., Ni) within an electrically conductive structure 134a (see FIGS. 2A-2C and corresponding description below). The electrodes 134, 136 also include an optical absorber structure 134b, which comprises an absorber layer 137 that includes a metal oxynitride (e.g., CrOₓN_{y}) (see FIGS. 2A-2C and corresponding description below). Further, the optical absorber structure 134b and the electrically conductive structure 134a are configured in these electrodes 134, 136 such that the metal layer of the electrically conductive structure 134a is of a metal that differs from the metal of the optical absorber structure 134b. For example, the metal of each of the electrically conductive structure 134a and the absorber layer 137 differ from one another, but can include any of the following materials: Cr, Mo, Au, Ag, Ni, Ti, Cu, Al, W, a Ni/Au alloy, a Ni/V alloy, a Au/Si alloy, Zr, V, a Cu/Ni alloy, other alloys thereof, or combinations thereof.

Referring again to the liquid lens 100 depicted in FIG. 1, either of or both of the first electrode 134 and the second electrode 136 can comprise two or more layers (e.g., an absorber structure 134b and an electrically conductive structure 134a, as shown in FIGS. 2A-2C), some of which can be conductive. The first electrode 134 functions as a common electrode in electrical communication with the first liquid 124. The second electrode 136 functions as a driving electrode. The second electrode 136 is disposed on the through hole 120 as well as between the intermediate layer 112 and the second outer layer 110.

Once again referring to the liquid lens 100 depicted in FIG. 1, either or both of the first electrode 134 and the second electrode 136 can be characterized by some or all of the following optical properties. According to an implementation of the liquid lens 100, the electrodes 134, 136 can comprise a reflectivity minimum of about 3% or less at a visible wavelength within a range of 390 nm to 700 nm. In some embodiments, the electrodes 134, 136 can comprise a reflectivity minimum of about 3% or less, 2.5% or less, 2% or less, 1.5% or less, 1% or less, 0.5% or less, and all reflectivity minima between these values, as measured at a visible wavelength. As noted earlier, the electrodes 134, 136 of the disclosure with such low reflectivity levels in the visible spectrum help minimize stray optical reflections within the cone and aperture of the liquid lens 100 that could otherwise degrade optical performance of the lens. In some implementations of the liquid lens 100, the electrodes 134, 136 can comprise a reflectivity of about 25% or less at an ultraviolet (UV) wavelength within a range of 100 nm to 400 nm. In some embodiments, the electrodes 134, 136 can comprise a reflectivity of about 25% or less, 20% or less, 15% or less, 10% or less, 5% or less, 1% or less, and all reflectivity values between these limits, as measured at a UV wavelength. As also noted earlier, the electrodes 134, 136 of the disclosure with these low reflectivity levels in the UV spectrum are a factor in ensuring that laser processes can be employed effectively to bond the substrates 112 and 124 together, particularly with a UV laser. In particular, these low reflectivity levels in the electrodes 134, 136 reduce the laser input energy for bonding, which can also reduce temperature increases, particularly in proximity to the liquids 124, 126. According to some embodiments of the liquid lens 100, the electrodes 134, 136 can comprise an optical transmittance of at least about 70% at an infrared (IR) wavelength within a range of 800 nm to 1700 nm. In embodiments, the electrodes 134, 136 can comprise an optical transmittance of at least about 70%, 75%, 80%, 85%, 90%, 95%, and all optical transmittance levels between these values, as measured at an IR wavelength. As noted earlier, the liquid lens 100 of the disclosure with electrodes 134 having such optical transmittance levels in the IR spectrum can enable a bond 146, as defined at least in part by the electrode 134, to be sufficiently transparent to the wavelength range of lasers that can be employed in subsequent dicing operations (e.g., from 800 nm to 1.7 μm).

Once again referring to the liquid lens 100 depicted in FIG. 1, either or both of the first electrode 134 and the second electrode 136 can be characterized by some or all of the following electrical properties. According to an implementation of the liquid lens 100, the electrodes 134, 136 can comprise a sheet resistance from about 5 Ω/sq to about 0.5 Ω/sq. In some implementations of the liquid lens 100, the electrodes 134, 136 can comprise a sheet resistance of about 5 Ω/sq, 4.5 Ω/sq, 4.0 Ω/sq, 3.5 Ω/sq, 3.0 Ω/sq, 2.5 Ω/sq, 2.0 Ω/sq, 1.5 Ω/sq, 1.0 Ω/sq, 0.5 Ω/sq, and all sheet resistance values between these sheet resistance levels. With these sheet resistance levels, the electrodes 134, 136 have current carrying capability to allow for the induced voltage variations associated with proper operation of the device employing the liquid lens 100. These sheet resistance levels in the electrodes 134, 136 are also at a level that heater electrodes (e.g., resistance-heater electrodes) patterned from them can be configured to heat the device employing the liquid lens 100 to improve operation under low (e.g., sub-zero) temperature evolutions.

The second electrode 136 is insulated from the first liquid 124 and the second liquid 126, via an insulating layer 140. The insulating layer 140 can comprise an insulating coating applied to the intermediate layer 112 before attaching the first outer layer 108 and/or the second outer layer 110 to the intermediate layer 112. The insulating layer 140 can comprise an insulating coating applied to the second electrode 136 and the second window 132 after attaching the second outer layer 110 to the intermediate layer 112 and before attaching the first outer layer 108 to the intermediate layer 112. Thus, the insulating layer 140 covers at least a portion of the second electrode 136 within the cavity 122 and the second window 132. The insulating layer 140 can be sufficiently transparent to enable passage of image light through the second window 132 as described herein. The insulating layer 140 can cover at least a portion of the second electrode 136 (acting as the driving electrode) (e.g., the portion of the second electrode 136 disposed within the cavity 122) to insulate the first liquid 124 and the second liquid 126 from the second electrode 136. Additionally, or alternatively, at least a portion of the first electrode 134 (acting as the common electrode) disposed within the cavity 122 is uncovered by the insulating layer 140. Thus, the first electrode 134 can be in electrical communication with the first liquid 124 as described herein.

The liquid lens 100 depicted in FIG. 1 can include one or more apertures through the first outer layer 108 (not shown). The apertures comprise portions of the liquid lens 100 at which the first electrode 134 is exposed through the first outer layer 108, such as via removal of a portion of the first outer layer 108 or otherwise. Thus, the apertures are configured to enable electrical connection to the first electrode 134, and the regions of the first electrode 134 exposed at the apertures can serve as contacts to enable electrical connection of the liquid lens 100 to a controller, a driver, or another component of a lens or camera system (not shown). In other words, the apertures provide an electrical contact point between the liquid lens 100 and another electrical device. In embodiments, the interconnections between the liquid lens 100, and specifically the first electrode 134, to another component of the lens can be made with a single step of etching or patterning of electrode 134 prior to the interconnection step. For example, the metal oxynitride (e.g., CrOₓN_{y}) of the optical absorber structure 134b can be etched with a cerium ammonium nitrate-based etchant (e.g., Transene 1020AC or TFE) to reveal the underlying electrically conductive structure 134a (e.g., a Ni metal layer).

Likewise, the liquid lens 100 depicted in FIG. 1 can also comprise one or more apertures through the second outer layer 110, according to some embodiments (not shown). These apertures comprise portions of the liquid lens 100 at which the second electrode 136 is exposed through the second outer layer 110, such as via removal of a portion of the second outer layer 110 or otherwise. Thus, the apertures are configured to enable electrical connection to the second electrode 136, and the regions of the second electrode 136 exposed at the apertures can serve as contacts to enable electrical connection of the liquid lens 100 to a controller, a driver, or another component of a lens or camera system (not shown). In embodiments, the interconnections between the liquid lens 100, and specifically the second electrode 136, to another component of the lens can be made with a single step of etching or patterning of electrode 136 prior to the interconnection step. For example, a metal oxynitride (e.g., CrOₓN_{y}) of the optical absorber structure of the second electrode 136 can be etched with an cerium ammonium nitrate-based etchant (e.g., Transene 1020AC or TFE) to reveal the underlying electrically conductive structure (e.g., a Ni metal layer), according to embodiments of the disclosure.

Referring again to the liquid lens 100 depicted in FIG. 1, the prior-described apertures (not shown) provide an electrical contact point between the liquid lens 100 and another electrical device. Different voltages can be supplied to the first electrode 134 and the second electrode 136 via the apertures (and the attendant interconnections) to change the shape of the interface 128, a process referred to as electrowetting. For example, applying a voltage to increase or decrease the wettability of the surface of the cavity 122 with respect to the first liquid 124 can change the shape of the interface 128. Changing the shape of the interface 128 can change the focal length or focus of the liquid lens 100. For example, such a change of focal length can enable the liquid lens 100 to perform a Autofocus function. Additionally, or alternatively, adjusting the interface 128 can tilt the interface 128 relative to the optical axis 114 of the liquid lens 100. For example, such tilting can enable the liquid lens 100 to perform an optical image stabilization (OIS) function. Adjusting the interface 128 can be achieved without physical movement of the liquid lens 100 relative to an image sensor, a fixed lens or lens stack, a housing, or other components of a camera module in which the liquid lens 100 can be incorporated.

According to an embodiment of the liquid lens 100 depicted in FIG. 1, the liquid lens includes a bond 146 defined at least in part by the electrode 134, wherein the bond 146 hermetically seals the first outer layer 108 to the intermediate layer 112. In embodiments, the bond 146 can be characterized by an optical transmittance of at least 70% at an infrared wavelength within a range of 800 nm to 1.7 μm, e.g., such that the bond 146 is transparent to the wavelength of a laser employed in subsequent dicing operations (e.g., 1060 nm for an infrared CO₂ laser). In some embodiments, the structure and composition of the electrode 134 is configured such that the bond 146 within the liquid lens 100 results in (a) an electrode 134 that is diffused, partially diffused melted, or otherwise incorporated into the first outer layer 108 and the intermediate layer 112 and (b) a bond 146 is transparent to the wavelength range of lasers that can be employed in subsequent dicing operations (e.g., from 800 nm to 1.7 μm). In other words, the first outer layer 108 is bonded with the intermediate layer 112 at the bond 146, and the resulting bond formed enables subsequent dicing operations. In some embodiments, the bond 146 includes a portion of the electrode 134 diffused into both the first outer layer 108 and the intermediate layer 112. In embodiments, the second outer layer 110 is bonded with the intermediate layer 112 at a bond that can be configured as described herein with reference to the bond 146. For example, the bonds between the first outer layer 108 and the intermediate layer 112 and between the second outer layer 110 and the intermediate layer 112 can be aligned with each other such that a transparent dicing pathway extends entirely or substantially entirely through the thickness of the liquid lens 100. The transparent dicing pathway can be transparent to the wavelength range of lasers that can be employed in subsequent dicing operations as described herein.

Referring now to FIGS. 2A-2C, a liquid lens article 100a is depicted according to various embodiments. In embodiments, the liquid lens 100 depicted in FIG. 1 includes or otherwise incorporates a liquid lens article 100a (e.g., as a subassembly or precursor element), and like-numbered elements in FIGS. 1-2C have the same or a substantially similar structure and function. The liquid lens article 100a depicted in FIGS. 2A-2C includes a first substrate 112 with a primary surface 112a. The liquid lens article 100a also includes an electrode 134 disposed on the primary surface 112a of the first substrate 112. The electrode 134 of the liquid lens article 100a includes an electrically conductive structure 134a disposed on the primary surface 112a of the first substrate 112 and an optical absorber structure 134b (see FIGS. 2A-2C) disposed on the electrically conductive structure 134a. Further, the absorber structure 134b comprises an absorber layer 137 comprising a metal oxynitride (e.g., CrOₓN_{y}) and the electrically conductive structure 134a comprises a metal layer comprising a metal (e.g., Ni) that differs from the metal of the absorber layer 137 of the absorber structure 134b. The properties and various compositions associated with each of the layers and structures of the electrode 134 are described earlier in connection with the liquid lens 100 depicted in FIG. 1.

Referring again to the liquid lens article 100a depicted in FIGS. 2A-2C, the electrically conductive structure 134a can be fabricated from or otherwise include a metal or metal alloy that includes Cr, Mo, Au, Ag, Ni, Ti, Cu, Al, W, a Ni/V alloy, a Ni/Au alloy, a Au/Si alloy, Zr, V, a Cu/Ni alloy, other alloys thereof, or combinations thereof. The electrically conductive structure 134a can be fabricated from a single layer, multiple layers, a composite having a matrix or second phases including the above metal or metal alloy materials. An exemplary example is shown in FIG. 2A in which an embodiment of the liquid lens article 100a is configured with an electrically conductive structure 134a with one metal layer disposed between the first substrate 112 and the optical absorber structure 134b. Embodiments of the liquid lens article 100a can be configured with an electrically conductive structure 134a with a pair of metal layers disposed between the first substrate 112 and the optical absorber structure 134b (not shown). As another example, embodiments of the liquid lens article 100a can be configured with an electrically conductive structure 134a fabricated from three or more metal layers disposed between the first substrate 112 and the optical absorber structure 134b (not shown).

Referring again to the liquid lens article 100a depicted in FIGS. 2A-2C, embodiments of the electrically conductive structure 134a are fabricated from one or more layers or structures with a total thickness from about 5 nm to about 300 nm, from about 10 nm to about 250 nm, from about 25 nm to about 200 nm, or from about 30 nm to about 200 nm. In some embodiments, the thickness of the one or more layers of the electrically conductive structure 134a is about 5 nm, 10 nm, 20 nm, 25 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, and all thickness values between these thicknesses.

Referring to the liquid lens article 100a depicted in FIGS. 2A-2C, the optical absorber structure 134b comprises an optical absorber layer 137 comprising a metal oxynitride. In some implementations, the optical absorber layer 137 comprises CrOₓN_{y}. In some embodiments, the metal of each of the electrically conductive structure 134a and the absorber layer 137 differ, but can include any of the following materials: Cr, Mo, Au, Ag, Ni, Ti, Cu, Al, W, a Ni/Au alloy, a Ni/V alloy, a Au/Si alloy, Zr, V, a Cu/Ni alloy, other alloys thereof, or combinations thereof. In some embodiments, the optical absorber structure 134b of the liquid lens article 100a can comprise an optical absorber layer 137 having two or more metal oxynitride layers (e.g., a CrOₓN_{y}/CrOₓN_{y} configuration). For example, as shown in FIG. 2A, the absorber structure 134b comprises an absorber layer 137 comprising a metal oxynitride (e.g., CrOₓN_{y}) and the electrically conductive structure 134a comprises a metal layer comprising a metal (e.g., Ni) that differs from the metal (e.g., Cr) of the absorber layer 137 of the absorber structure 134b. As another example, as shown in FIG. 2B, the absorber layer 137 can comprise an outer absorber layer 236 disposed over an inner absorber layer 234, the outer absorber layer 236 comprising a metal oxynitride, e.g., CrOₓN_{y}, and the inner absorber layer 234 comprising Cr; and the metal layer of the electrically conductive structure 134a comprises Ni.

Referring again to the liquid lens article 100a depicted in FIGS. 2A-2C, embodiments of the optical absorber structure 134b are fabricated from multiple layers and/or structures with a total thickness from about 0.1 nm to about 200 nm, from about 0.5 nm to about 150 nm, from about 25 nm to about 135 nm, or from about 1 nm to about 150 nm. In some embodiments, the total thickness of the optical absorber structure 134b is about 0.1 nm, 0.5 nm, 1 nm, 5 nm, 10 nm, 20 nm, 25 nm, 30 nm, 40 nm, 50 nm, 60 nm, 70 nm, 80 nm, 90 nm, 100 nm, 110 nm, 120 nm, 130 nm, 135 nm, 140 nm, 150 nm, 160 nm, 170 nm, 180 nm, 190 nm, 200 nm, and all thickness values between these thicknesses.

In some implementations of the liquid lens article 100a depicted in FIG. 2B, the absorber layer 137 comprises an outer absorber layer 236 and an inner absorber layer 234. According to these implementations, the thickness of the outer absorber layer 236 can range from about 10 nm to 200 nm, from about 10 nm to about 150 nm, or from about 20 nm to about 100 nm. In some embodiments, the thickness the outer absorber 236 can be about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, 200 nm, and all thickness values between these values. As for the inner absorber layer 234, its thickness can range from about 1 nm to about 100 nm, from about 5 nm to about 75 nm, from about 5 nm to about 50 nm, or from about 5 nm to about 35 nm. In some embodiments, the thickness of the inner absorber layer 234 is about 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, and all thickness values between these levels.

Referring now to FIG. 2, a liquid lens article 100a is depicted in which the article further includes a second substrate 108 disposed on the optical absorber structure 134b (not shown) of the electrode 134. The liquid lens article 100a, as depicted in FIG. 2, further includes a bond 146 that is defined at least in part by the electrode 134. The bond 146 hermetically seals the first substrate 112 and the second substrate 108. As noted earlier in connection with the liquid lens 100 (see FIG. 1 and corresponding description), the bond 146 can be formed with a UV laser (e.g., a CO₂ laser at 1060 nm). Advantageously, as also noted earlier, the electrode 134, which is part of the bond 146, can be characterized by a reflectivity of about 25% or less at a UV wavelength, which facilitates the formation of the bond 146 with a UV laser. Further, according to some implementations, the bond 146, as formed from the electrode 134 and substrates 108, 112, can be characterized by an optical transmittance of at least 70% at an IR wavelength. Accordingly, the bonds 146 with such optical transmittance are advantageously configured to facilitate subsequent operations and processes to dice a liquid lens 100 (see FIG. 1) from an array of liquid lenses 100 (not shown) with an IR laser.

### EXAMPLES

The following example describes various features and advantages provided by the disclosure, and are in no way intended to limit the disclosure and appended claims.

### Example 1

In this example, a liquid lens article consistent with the liquid lens articles 100a of the disclosure was prepared (see FIG. 2B). As noted below in Table 1, the substrate has a glass composition and the electrode includes the following layers successively disposed over the substrate: a Ni layer having a thickness of 80 nm (e.g., an electrically conductive structure 134a); a Cr layer having a thickness of 15 nm (e.g., an inner absorber layer 234); and a CrOₓN_{y} layer having a thickness of 52 nm (e.g., an outer absorber layer 236). This sample configuration is denoted “Ex. 1”.

TABLE 1
Cr/ITO/Cr/ITO electrode (Ex. 1)

| Material | |
|---|---|
| glass substrate | Thickness |
| Ni film | 80 nm |
| Cr film | 15 nm |
| CrOₓN_{y} film | 52 nm |
| air | N/A |

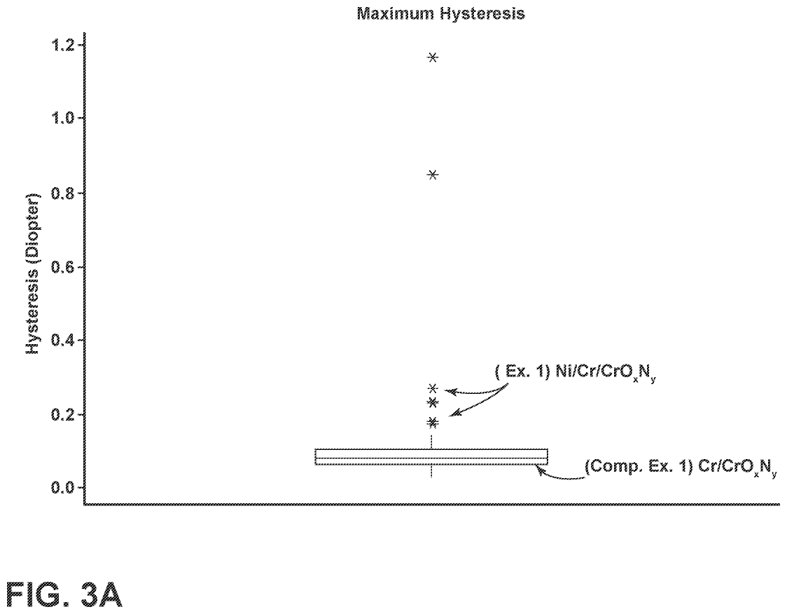

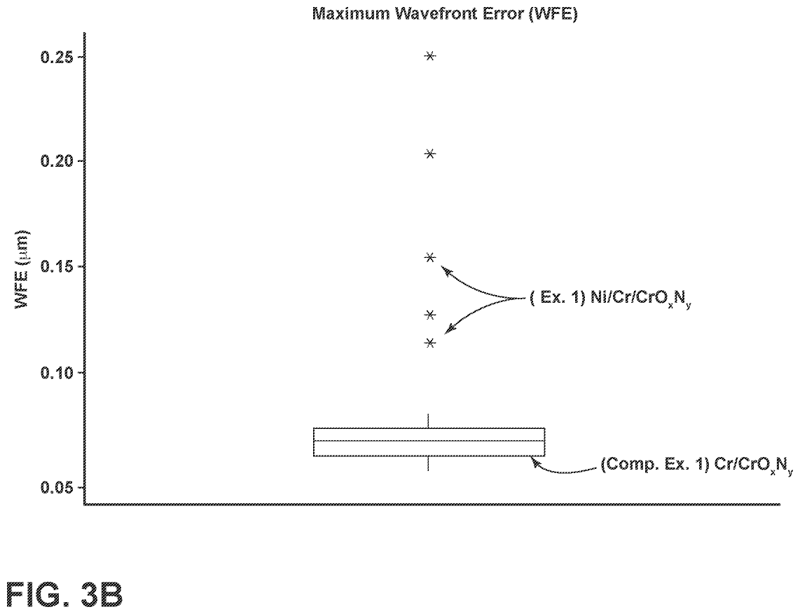

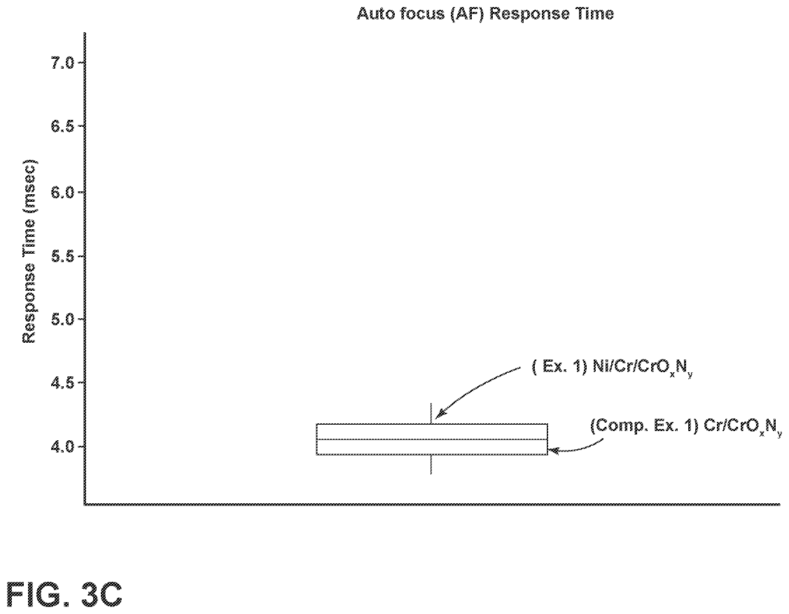

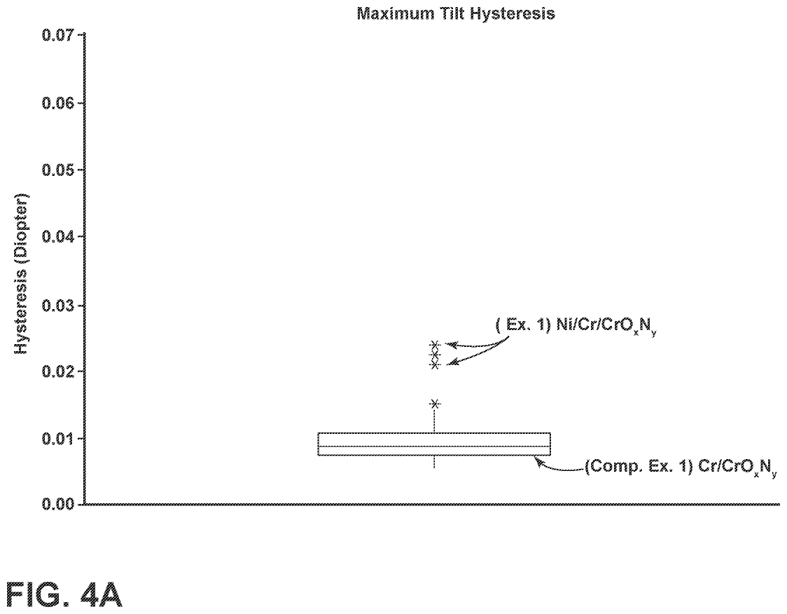

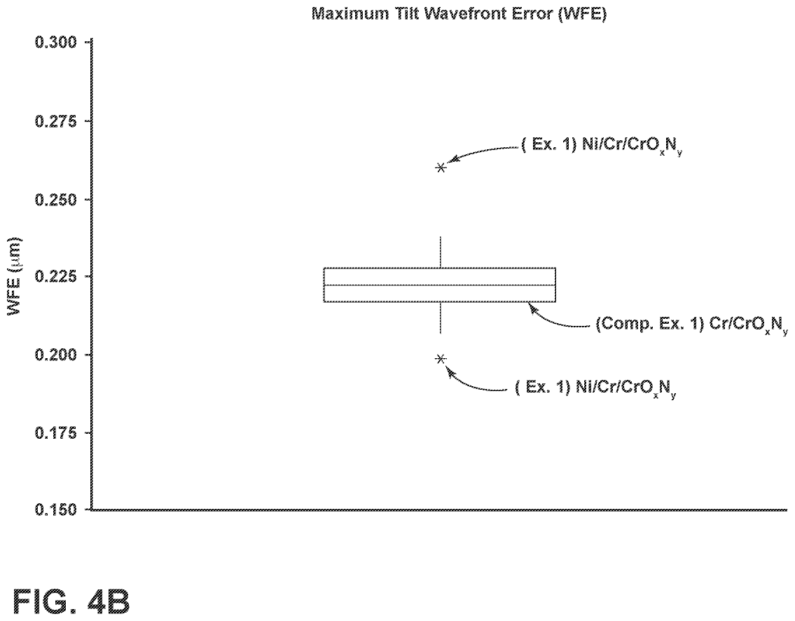

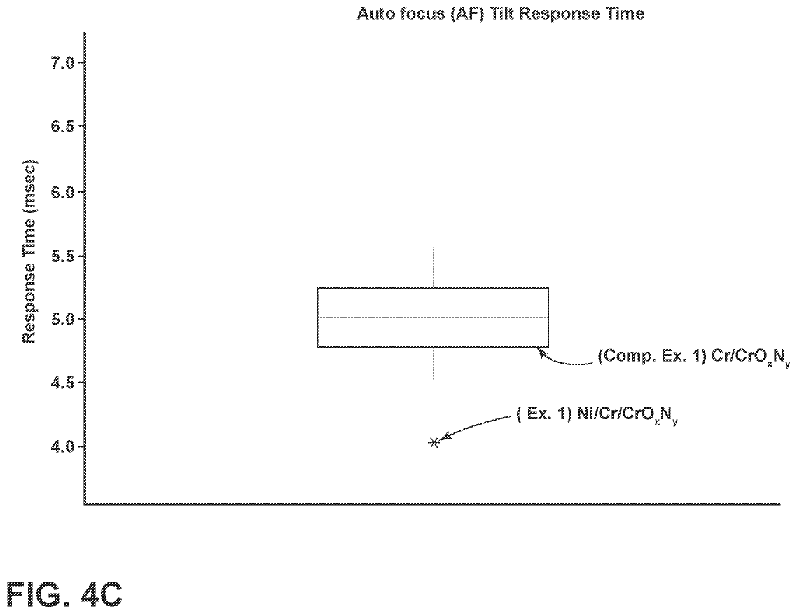

Referring now to FIGS. 3A-3C and 4A-4C, box plots of measured parameters of liquid lenses fabricated with a comparative Cr/CrOₓN_{y} electrode configuration (Comp. Ex. 1) and a Ni/Cr/CrOₓN_{y} electrode (e.g., an electrode comparable to the electrode configuration shown in FIG. 2B) configuration (Ex. 1). While comparative electrodes with the Cr/CrOₓN_{y} configurations generally exhibit optical properties that are comparable to those of the electrodes of the disclosure (e.g., low UV and visible spectra reflectivity), the CrOₓN_{y} portion of these electrodes is electrically insulating. As such, these electrodes should be etched or otherwise patterned prior to interconnection. Not only is the etching and patterning costly, the processes are often difficult to control as the etchants employed to etch the CrOₓN_{y} portion tend to etch the underlying electrical conductive metal layer(s). An advantage of the electrodes of the disclosure is that this etching can be conducted in one step with a single etchant such that the CrOₓN_{y} portion is removed or otherwise patterned, while leaving behind an electrically conductive structure comprising a metal that differs from Cr (e.g., Ni). For example, a cerium ammonium nitrate-based etchant can be employed to etch the CrOₓN_{y} portion of the electrodes of the Ni/Cr/CrOₓN_{y} electrode (Ex. 1).

Samples of each of these liquid lens devices, as fabricated with these electrode configurations (Comp. Ex. 1 and Ex. 1), were placed on an optical test bench with a Shack-Hartmann wavefront sensor optical instrument. A collimated light source was then used to generate incident light that passed through each of the liquid lens devices to reach the wavefront sensor. Data from the wavefront sensor was then employed to calculate power, tilt and wavefront error (WFE). More particularly, FIGS. 3A and 4A are box plots of maximum hysteresis for these samples in a non-tilted and tilted configuration, respectively, i.e., the maximum hysteresis in the power range of the liquid lens device reported in units of diopters. FIGS. 3B and 4B are a box plots of WFE in the power range of the liquid lens device reported in units of microns (μm) in a non-tilted and tilted configuration, respectively. FIGS. 3C and 4C are box plots of autofocus (AF) response time, as reported in milliseconds (msec) in a non-tilted and tilted configuration, respectively. The AF response time is the time it takes the liquid lens device to reach 90% of the desired final diopter from 10% of the starting diopter point. The corresponding voltage for the starting diopter is applied and a sufficient time is allowed for the lens to settle before the test is initiated. Upon initiation of the test, the voltage for the final diopter point is applied and the resulting diopter is measured in increments of 2 msec. From this data set, the 10% to 90% response time can be interpolated to generate the AF time. Ultimately, as is evident from the box plots in FIGS. 3A-3C and 4A-4C, the liquid lenses with the Ni/Cr/CrOₓN_{y} electrode configurations according to this disclosure (Ex. 1) exhibited comparable liquid lens device performance as liquid lens devices with the comparative Cr/CrOₓN_{y} electrode configuration (Comp. Ex. 1) in terms of maximum hysteresis, maximum wavefront error and autofocus response time, both in a non-tilted and tilted configuration.

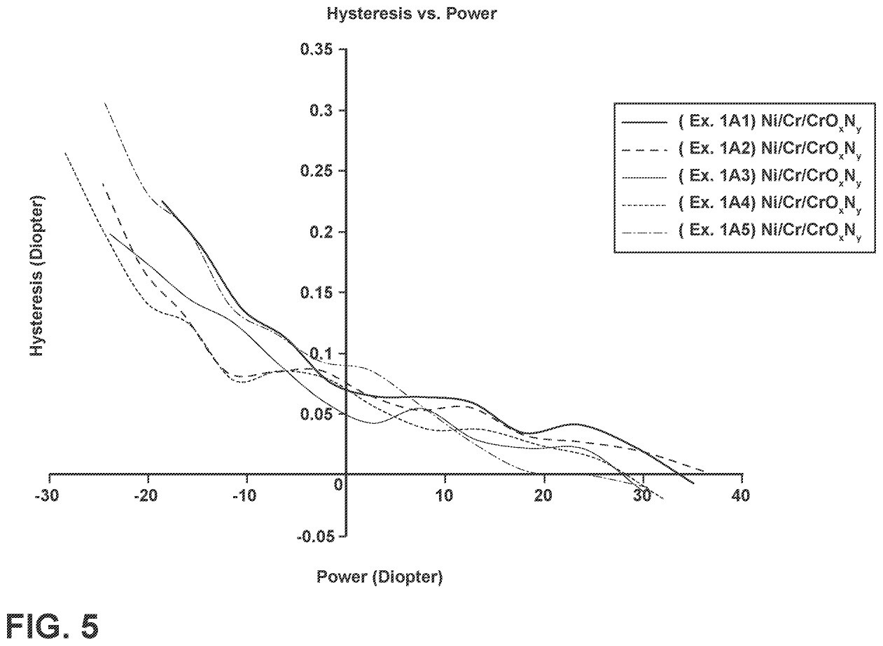

Referring now to FIG. 5, a plot of hysteresis vs. optical power of liquid lenses, as fabricated with exemplary Ni/Cr/CrOₓN_{y} electrode configurations (Exs. 1A1-1A5), is provided. Each of the five (5) samples of the Ni/Cr/CrOₓN_{y} electrode configuration shown in FIG. 5 were prepared according to Ex. 1, noted earlier. As is evident from FIG. 5, the change in the hysteresis observed from an optical power of 0 to 20 diopters is relatively small (i.e., the curve is relatively flat), which is a measure of liquid lens performance.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

According to a first aspect, a liquid lens article is provided. The liquid lens article comprises: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. Further, the absorber structure comprises an absorber layer comprising a metal oxynitride and the electrically conductive structure comprises a metal layer comprising a metal that differs from the metal of the absorber layer of the absorber structure.

According to a second aspect, the first aspect is provided, wherein the absorber layer of the absorber structure comprises CrOₓN_{y}, and the metal layer of the electrically conductive structure comprises Ni.

According to a third aspect, the first aspect is provided, wherein the absorber layer comprises an outer absorber layer disposed over an inner absorber layer, the outer absorber layer comprising CrOₓN_{y} and the inner absorber layer comprising Cr, and further wherein the metal layer of the electrically conductive structure comprises Ni.

According to a fourth aspect, either of the second or third aspect is provided, wherein the electrode further comprises a NiOₓ adhesion layer, the adhesion layer between the primary surface of the first substrate and the metal layer of the electrically conductive structure.

According to a fifth aspect, the first aspect is provided, wherein the absorber structure comprises a thickness from 25 nm to 135 nm and the electrically conductive structure comprises a thickness from about 25 nm to about 200 nm.

According to a sixth aspect, the third aspect is provided, wherein the outer absorber layer comprises a thickness from 20 nm to about 100 nm, the inner absorber layer comprises a thickness from about 5 nm to about 35 nm, and the electrically conductive structure comprises a thickness from about 25 nm to about 200 nm.

According to a seventh aspect, the first aspect is provided, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

According to an eighth aspect, the first aspect is provided, wherein the metal of each of the electrically conductive structure and the absorber layer is selected from the group consisting of Cr, Mo, Au, Ag, Ni, Ti, Cu, Al, V, W, Zr, a Ni/V alloy, a Ni/Au alloy, a Au/Si alloy, a Cu/Ni alloy, other alloys thereof, and combinations thereof

According to a ninth aspect, any one of the first through eighth aspects is provided, as further comprising: a second substrate disposed on the optical absorber structure of the electrode; and a bond defined at least in part by the electrode. The bond hermetically seals the first substrate and the second substrate. Further, the bond comprises an optical transmittance of at least 70% at an infrared wavelength within a range of 800 nm to 1.7 μm.

According to a tenth aspect, a liquid lens article is provided. The liquid lens article comprises: a first substrate; and an electrode disposed on a primary surface of the first substrate. The electrode comprises an electrically conductive structure disposed on the primary surface of the first substrate and an optical absorber structure disposed on the electrically conductive structure. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. The absorber structure comprises an absorber layer comprising a metal oxynitride and the electrically conductive structure comprises a metal layer comprising a metal that differs from the metal of the absorber layer of the absorber structure. Further, the electrode comprises a sheet resistance from about 5 Ω/sq to about 0.5 Ω/sq.

According to an eleventh aspect, the tenth aspect is provided, wherein the absorber layer of the absorber structure comprises CrOₓN_{y}, and the metal layer of the electrically conductive structure comprises Ni.

According to a twelfth aspect, the tenth aspect is provided, wherein the absorber layer comprises an outer absorber layer disposed over an inner absorber layer, the outer absorber layer comprising CrOₓN_{y} and the inner absorber layer comprising Cr. Further, the metal layer of the electrically conductive structure comprises Ni.

According to a thirteenth aspect, either of the eleventh or twelfth aspects is provided, wherein the electrode further comprises a NiOₓ adhesion layer, the adhesion layer between the primary surface of the first substrate and the metal layer of the electrically conductive structure.

According to a fourteenth aspect, the tenth aspect is provided, wherein the absorber structure comprises a thickness from 25 nm to 135 nm and the electrically conductive structure comprises a thickness from about 25 nm to about 200 nm.

According to a fifteenth aspect, the twelfth aspect is provided, wherein the outer absorber layer comprises a thickness from 20 nm to about 100 nm, the inner absorber layer comprises a thickness from about 5 nm to about 35 nm, and the electrically conductive structure comprises a thickness from about 25 nm to about 200 nm.

According to a sixteenth aspect, the tenth aspect is provided, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

According to a seventeenth aspect, the tenth aspect is provided, wherein the metal of each of the electrically conductive structure and the absorber layer is selected from the group consisting of Cr, Mo, Au, Ag, Ni, Ti, Cu, Al, V, W, Zr, a Ni/V alloy, a Ni/Au alloy, a Au/Si alloy, a Cu/Ni alloy, other alloys thereof, and combinations thereof.

According to an eighteenth aspect, any one of the tenth through seventeenth aspects is provided, as further comprising: a second substrate disposed on the optical absorber structure of the electrode; and a bond defined at least in part by the electrode. The bond hermetically seals the first substrate and the second substrate. Further, the bond comprises an optical transmittance of at least 70% at an infrared wavelength within a range of 800 nm to 1.7 μm.

According to a nineteenth aspect, any one of the tenth through eighteenth aspects is provided, wherein the electrode comprises a sheet resistance from about 3 Ω/sq to about 0.5 Ω/sq.

According to a twentieth aspect, a liquid lens is provided. The liquid lens comprises a first substrate; an electrode disposed on a primary surface of the first substrate and comprising an electrically conductive structure disposed on the primary surface of the first substrate and an optical absorber structure disposed on the electrically conductive structure; a second substrate disposed on the absorber structure of the electrode; a bond defined at least in part by the electrode, wherein the bond hermetically seals the first substrate and the second substrate; a cavity defined at least in part by the bond; and a first liquid and a second liquid disposed within the cavity. The electrode comprises a reflectivity minimum of about 3% or less at a visible wavelength within a range of 390 nm to 700 nm, and a reflectivity of about 25% or less at an ultraviolet wavelength within a range of 100 nm to 400 nm. The absorber structure comprises an absorber layer comprising a metal oxynitride and the electrically conductive structure comprises a metal layer comprising a metal that differs from the metal of the absorber layer of the absorber structure. Further, the first liquid and the second liquid are substantially immiscible such that an interface between the first liquid and the second liquid defines a lens of the liquid lens.

According to a twenty-first aspect, the twentieth aspect is provided, wherein the absorber layer of the absorber structure comprises CrOₓN_{y}, and the metal layer of the electrically conductive structure comprises Ni.

According to a twenty-second aspect, the twentieth aspect is provided, wherein the absorber layer comprises an outer absorber layer disposed over an inner absorber layer, the outer absorber layer comprising CrOₓN_{y} and the inner absorber layer comprising Cr, and further wherein the metal layer of the electrically conductive structure comprises Ni.

According to a twenty-third aspect, either of the twenty-first or twenty-second aspects is provided, wherein the electrode further comprises a NiOₓ adhesion layer, the adhesion layer between the primary surface of the first substrate and the metal layer of the electrically conductive structure.

According to a twenty-fourth aspect, the twentieth aspect is provided, wherein the absorber structure comprises a thickness from 25 nm to 135 nm and the electrically conductive structure comprises a thickness from about 25 nm to about 200 nm.

According to a twenty-fifth aspect, the twenty-second aspect is provided, wherein the outer absorber layer comprises a thickness from 20 nm to about 100 nm, the inner absorber layer comprises a thickness from about 5 nm to about 35 nm, and the electrically conductive structure comprises a thickness from about 25 nm to about 200 nm.

According to a twenty-sixth aspect, the twentieth aspect is provided, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

According to a twenty-seventh aspect, the twentieth aspect is provided, wherein the metal of each of the electrically conductive structure and the absorber layer is selected from the group consisting of Cr, Mo, Au, Ag, Ni, Ti, Cu, Al, V, W, Zr, a Ni/V alloy, a Ni/Au alloy, a Au/Si alloy, a Cu/Ni alloy, other alloys thereof, and combinations thereof

According to a twenty-eighth aspect, the twentieth aspect is provided, wherein the electrode comprises a sheet resistance from about 5 Ω/sq to about 0.5 Ω/sq.

According to a twenty-ninth aspect, any one of the twentieth through twenty-eighth aspects is provided, wherein the bond comprises an optical transmittance of at least 70% at an infrared wavelength within a range of 800 nm to 1.7 μm.

1. A liquid lens article, comprising:
a first substrate; and
an electrode disposed on a primary surface of the first substrate,
wherein the electrode comprises an electrically conductive structure disposed on the primary surface of the first substrate and an optical absorber structure disposed on the electrically conductive structure,
wherein the electrode comprises a reflectivity minimum of about 3% or less at a visible wavelength within a range of 390 nm to 700 nm, and a reflectivity of about 25% or less at an ultraviolet wavelength within a range of 100 nm to 400 nm, and
further wherein the absorber structure comprises an absorber layer comprising a metal oxynitride and the electrically conductive structure comprises a metal layer comprising a metal that differs from the metal of the absorber layer of the absorber structure.

2. The liquid lens article according to claim 1, wherein the absorber layer of the absorber structure comprises CrOₓN_{y}, and the metal layer of the electrically conductive structure comprises Ni.

3. The liquid lens article according to claim 1, wherein the absorber layer comprises an outer absorber layer disposed over an inner absorber layer, the outer absorber layer comprising CrOₓN_{y} and the inner absorber layer comprising Cr, and further wherein the metal layer of the electrically conductive structure comprises Ni.

4. The liquid lens article according to claim 1, wherein the electrode further comprises a NiOₓ adhesion layer, the adhesion layer between the primary surface of the first substrate and the metal layer of the electrically conductive structure.

5. The liquid lens article according to claim 1, wherein the absorber structure comprises a thickness from 25 nm to 135 nm and the electrically conductive structure comprises a thickness from about 25 nm to about 200 nm.

6. The liquid lens article according to claim 3, wherein the outer absorber layer comprises a thickness from 20 nm to about 100 nm, the inner absorber layer comprises a thickness from about 5 nm to about 35 nm, and the electrically conductive structure comprises a thickness from about 25 nm to about 200 nm.

7. The liquid lens article according to claim 1, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

8. The liquid lens article according to claim 1, wherein the metal of each of the electrically conductive structure and the absorber layer is selected from the group consisting of Cr, Mo, Au, Ag, Ni, Ti, Cu, Al, V, W, Zr, a Ni/V alloy, a Ni/Au alloy, a Au/Si alloy, a Cu/Ni alloy, other alloys thereof, and combinations thereof.

9. The liquid lens article according to claim 1, further comprising:
a second substrate disposed on the optical absorber structure of the electrode; and
a bond defined at least in part by the electrode,
wherein the bond hermetically seals the first substrate and the second substrate, and
further wherein the bond comprises an optical transmittance of at least 70% at an infrared wavelength within a range of 800 nm to 1.7 μm.

10. The liquid lens article according to claim 1,
wherein the electrode comprises a sheet resistance from about 5 Ω/sq to about 0.5 Ω/sq.

11-19. (canceled)

20. A liquid lens, comprising:
a first substrate;
an electrode disposed on a primary surface of the first substrate and comprising an electrically conductive structure disposed on the primary surface of the first substrate and an optical absorber structure disposed on the electrically conductive structure;
a second substrate disposed on the absorber structure of the electrode;
a bond defined at least in part by the electrode, wherein the bond hermetically seals the first substrate and the second substrate;
a cavity defined at least in part by the bond; and
a first liquid and a second liquid disposed within the cavity,
wherein the electrode comprises a reflectivity minimum of about 3% or less at a visible wavelength within a range of 390 nm to 700 nm, and a reflectivity of about 25% or less at an ultraviolet wavelength within a range of 100 nm to 400 nm,
wherein the absorber structure comprises an absorber layer comprising a metal oxynitride and the electrically conductive structure comprises a metal layer comprising a metal that differs from the metal of the absorber layer of the absorber structure, and
further wherein the first liquid and the second liquid are substantially immiscible such that an interface between the first liquid and the second liquid defines a lens of the liquid lens.

21. The liquid lens according to claim 20, wherein the absorber layer of the absorber structure comprises CrOₓN_{y}, and the metal layer of the electrically conductive structure comprises Ni.

22. The liquid lens according to claim 20, wherein the absorber layer comprises an outer absorber layer disposed over an inner absorber layer, the outer absorber layer comprising CrOₓN_{y} and the inner absorber layer comprising Cr, and further wherein the metal layer of the electrically conductive structure comprises Ni.

23. The liquid lens according to claim 20, wherein the electrode further comprises a NiOₓ adhesion layer, the adhesion layer between the primary surface of the first substrate and the metal layer of the electrically conductive structure.

24. The liquid lens according to claim 20, wherein the absorber structure comprises a thickness from 25 nm to 135 nm and the electrically conductive structure comprises a thickness from about 25 nm to about 200 nm.

25. The liquid lens according to claim 22, wherein the outer absorber layer comprises a thickness from 20 nm to about 100 nm, the inner absorber layer comprises a thickness from about 5 nm to about 35 nm, and the electrically conductive structure comprises a thickness from about 25 nm to about 200 nm.

26. The liquid lens according to claim 20, wherein the electrode comprises a reflectivity minimum of about 1% or less at the visible wavelength within the range of 390 nm to 700 nm, and a reflectivity of about 5% or less at the ultraviolet wavelength within the range of 100 nm to 400 nm.

27. The liquid lens according to claim 20, wherein the metal of each of the electrically conductive structure and the absorber layer is selected from the group consisting of Cr, Mo, Au, Ag, Ni, Ti, Cu, Al, V, W, Zr, a Ni/V alloy, a Ni/Au alloy, a Au/Si alloy, a Cu/Ni alloy, other alloys thereof, and combinations thereof.

28. The liquid lens according to claim 20, wherein the electrode comprises a sheet resistance from about 5 Ω/sq to about 0.5 Ω/sq.

29. The liquid lens according to claim 20, wherein the bond comprises an optical transmittance of at least 70% at an infrared wavelength within a range of 800 nm to 1.7 μm.
